(19) United States
(12) Patent Application Publication
(10) Pub. No.: US 2017/0206306 A1
(43) Pub. Date: Jul. 20, 2017

(54) DEVICE AND METHOD FOR THREE-DIMENSIONAL DIGITAL MODELLING

(71) Applicant: DEFACTO, Paris (FR)

(72) Inventors: Noureddine MADOUI, Hannover (DE); Amin LAAROUSSI, Sfax (TN)

(21) Appl. No.: 15/314,277

(22) PCT Filed: May 21, 2015
(86) PCT No.: PCT/EP2015/061284

§ 371 Date: Nov. 28, 2016

(30) Foreign Application Priority Data
May 27, 2014 (FR) 1454750

(51) Int. Cl. G06F 17/50

(52) U.S. Cl. CPC G06F 17/5095; G06F 2217/02

(57) ABSTRACT

A method for three-dimensional modelling of a component, includes: selecting, with an interface, a three-dimensional reference model from a plurality of reference models, each reference model modelling a component, each component having a list of technical features, selecting at least part of the technical features, the part of the technical features having a first variability which ensures the functionality of the component, inputting a value for each technical feature, checking by a computer the compliance of each value input by the user with respect to the first variability and with respect to a second variability of the part of the technical features, the second variability ensuring the certifiability of the component, and, if compliance of each value input by the user with respect to the first and second variabilities, generating, by the computer, a particular digital model of the component, the functionality and the certifiability of which are ensured.

### TECHNICAL FIELD OF THE INVENTION

The technical field of the invention is that of digital modelling. The present invention relates to a device and method for three-dimensional digital modelling, in particular for transport industries, such as the aeronautics industry, the railway industry, the automobile industry or the maritime industry.

### TECHNOLOGICAL BACKGROUND OF THE INVENTION

Each ecosystem is characterised by a permanent interaction between several trades of the ecosystem. In the particular case of the aeronautics industry, the four main trades of the ecosystem are typically:
The trade of operator OPS, or “airline company”. The operator OPS is the final client;
The trade of aircraft manufacturer OEM (Original Equipment Manufacturer), or “aircraft builder”. An aircraft builder may work for several operators OPS;
The trade of equipment manufacturer and the trade of specialist CCC (Cabin Completion Centre). An equipment manufacturer and a specialist may work for several aircraft manufacturers OEM.

In systems engineering, a fundamental notion is the “V cycle”. The V cycle defines a manner of going from a functional specification of a need to a physical realisation of an object meeting this need.

Furthermore, in order to optimise development and prototyping costs, the notion of digital mock-up has taken a preponderant place in PLM (Product Lifecycle Management).

In the aeronautics industry, for the certification of a series, an AS (Aircraft Standard) development aircraft and typically three or four physical aircraft prototypes are necessary. FIG. 1 thus illustrates an example of a V cycle, in the particular case of the interaction between an aircraft manufacturer and an equipment manufacturer for the realisation of a development aircraft. This V cycle is called the “primary cycle”. The aircraft manufacturer realises a first feasibility study step E1, then a second design step E2. A third definition step E3 is realised by the aircraft manufacturer and the equipment manufacturer. The equipment manufacturer then realises a fourth development step E4. A fifth integration step E5 is realised by the equipment manufacturer and the aircraft manufacturer. The fifth integration step E5 is the practical implementation of the third, theoretical definition step E3. The aircraft manufacturer then realises a sixth step E6 of tests, corresponding to a practical implementation of the second theoretical design step E2, then a seventh entry-into-service step E7, which is the practical realisation of the first theoretical feasibility study step E1.

A selection of operators with high potential, that is to say companies of global dimension and having at their disposal considerable financial resources, is then established, and an “operator HOV” (Head Of Version) is realised for each of these operators. Each head of version HOV is a particular configuration of the AS development aircraft. From one head of version to the other, it is notably the internal lay-out of the cabin of the aircraft that is personalised and which varies. For each head of version HOV, a V cycle, known as “secondary cycle” is used.

The creation of a personalised aircraft cabin or the modification of a pre-existing aircraft cabin require several engineering steps.
A first step is the spatial configuration of the different components of said aircraft cabin. The components of an aircraft cabin are for example seats, partitions, offices or “galleys”. A lay-out plan of the cabin, known as LOPA (Lay-Out Passenger Arrangement), is realised at the end of this first step.
A second step is the design of the components of the selected LOPA plan, and the verification of the certifiability of said components.
A third step is the virtual realisation, typically in three dimensions, of said components, and the feasibility study of their integration in a digital mock-up, with a view to a test phase.
A fourth step is the industrialisation of the components and their installation in the aircraft cabin.

In the case of the aeronautics industry, the duration of the primary cycle is of the order of eight years, and the duration of each secondary cycle is of the order of eight months.

In order to reduce the time-to-market of each product, it involves for the aircraft manufacturer OEM reducing the duration of the primary development cycle and/or the duration of each secondary development cycle.

The document U.S. Pat. No. 8,239,173B2, which proposes a computer aided design system of technical components, makes it possible to facilitate and accelerate the first step of spatial configuration of the different components within an aircraft cabin. Nevertheless, the second step of certification of the components and the third step of integration of the components within an environment are not taken into account by this document. Moreover, the design system of the document U.S. Pat. No. 8,239,173B2 is a two-dimensional design system.

### SUMMARY OF INVENTION

The invention offers a solution to the aforementioned problems and makes it possible to reduce significantly the duration of each secondary development cycle, by proposing a method for three-dimensional modelling of components making it possible to capitalise on design work and computing time.

One aspect of the invention thus relates to a method for three-dimensional modelling of a component, the method comprising the following steps:
a step wherein a user selects, by means of an interface, a three-dimensional reference model from a plurality of three-dimensional reference models stored in a digital storage warehouse, each three-dimensional reference model modelling a component, each component having a list of technical features;
a step wherein the user selects, by means of the interface, at least part of the technical features of the list of technical features of said component, said at least part of the technical features having a first variability which ensures the functionality of said component;
a step wherein the user inputs, by means of the interface, a value for each technical feature of said at least part of the technical features;
a step wherein a computer checks the compliance of each value input by the user with respect to the first variability ensuring the functionality of the component and with respect to a second variability of said at least part of the technical features, the second variability ensuring the certifiability of the component;
in the case of compliance of each value input by the user with respect to the first and second variabilities, a step of generating, by means of the computer, a particular digital model of the component, the functionality and the certifiability of which are ensured.

The method for three-dimensional digital modelling according to one aspect of the invention thus makes it possible to generate, for a given component, a particular three-dimensional digital model which ensures the functionality and the certifiability of said component.

Apart from the characteristics that have been described in the preceding paragraph, the method for three-dimensional modelling according to one aspect of the invention may have one or more of the additional characteristics among the following, considered individually or according to any technically possible combinations thereof:
The method comprises a step of storing the particular digital model of the component in the digital storage warehouse.
The method comprises a step of automatic and error-free integration, by means of the computer, of the particular digital model of the component in a spatial environment.
Said at least part of the technical features comprises a first technical feature and a second technical feature, and a priority rule is established between said first and second technical features.
Said at least part of the technical features comprises a first technical feature and a second technical feature, and a behaviour rule of the first technical feature as a function of the second technical feature and/or a behaviour rule of the second technical feature as a function of the first technical feature are determined.
The first variability of said at least part of the technical features of the list of technical features of said component is established as a function of the functional dimensions of said component.
The second variability of said at least part of the technical features of the list of technical features of said component is established as a function of a first sub-set of rules specific to a given technical field.
The second variability of said at least part of the technical features of the list of technical features of said component is established as a function of:
   a second sub-set of rules specific to a given trade of the technical field considered, and/or
   a third sub-set of specifications specific to a given player of the trade considered.
The method comprises a step of identification, by means of the computer, of the particular digital model of the component by means of a tag, the tag comprising:
   the technical features of said at least part of said list of technical features of said component, and
   the values of each of said technical features.
The method comprises a step of encryption, by means of the computer, of said tag in order to ensure the inviolability of said tag.

Another aspect of the invention relates to a computer programme product comprising means for the implementation of the method for three-dimensional modelling of a component according to one aspect of the invention.

The invention and its different applications will be better understood on reading the description that follows and by examining the figures that accompany it.

### BRIEF DESCRIPTION OF THE FIGURES

The figures are presented for indicative purposes and in no way limit the invention.

FIG. 1 schematically illustrates an example of a V cycle according to the prior art, in the particular case of interaction between an aircraft manufacturer and an equipment manufacturer for the realisation of a development aircraft.

FIG. 2 is a flow diagram of a method for three-dimensional modelling according to one aspect of the invention.

FIG. 3a schematically illustrates a first level of operation and use of the method for three-dimensional modelling according to one aspect of the invention.

FIG. 3b schematically illustrates a second level of operation and use of the modelling method according to one aspect of the invention.

FIG. 4a shows a first schematic representation of a device for three-dimensional digital modelling according to one aspect of the invention.

FIG. 4b shows a second schematic representation of the device for three-dimensional digital modelling according to one aspect of the invention.

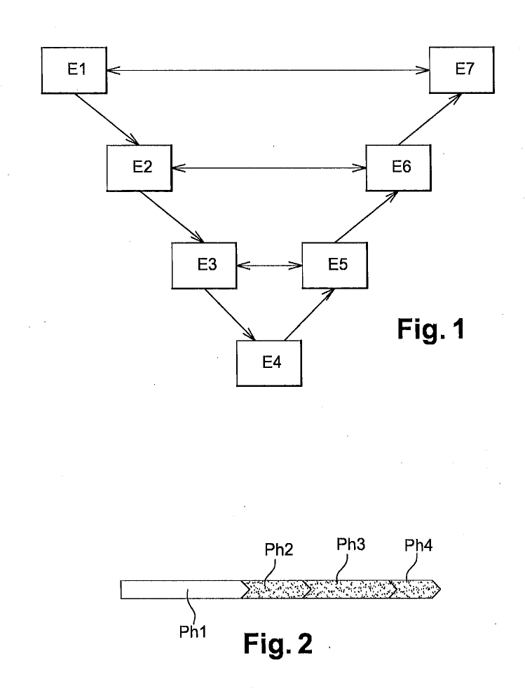

### DETAILED DESCRIPTION OF AT LEAST ONE EMBODIMENT OF THE INVENTION

Unless stated otherwise, a same element appearing in the different figures has a single reference.

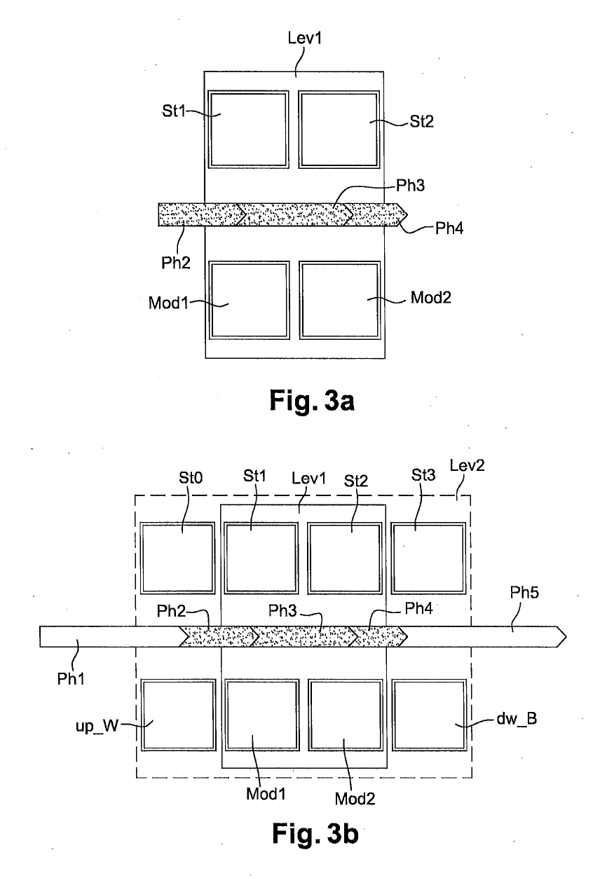

FIG. 2 is a flow diagram of a method for three-dimensional modelling according to one aspect of the invention. The flow diagram of FIG. 2 comprises several phases.

A first phase Ph1 is the identification of recurring components and the inventory of the technical features associated with each recurring component. Each recurring component has at least one technical feature. “Recurring component” is taken to mean a component destined to be modelled then manufactured several times in a generic manner. A recurring component is for example a seat.

The technical features of a recurring component are typically:
one or more geometric features, and/or
one or more dimensional features, and/or
one or more proportional features, and/or
one or more features of absolute emplacement of the recurring component with respect to an environment.

“Absolute emplacement of a recurring component within an environment” is taken to mean the fact that there exists a condition of positioning a given recurring component with respect to an environment, for example an aircraft cabin or a train compartment, independently of potential other elements of the environment. The dimensions of the environment are known. For example, if the recurring component is a seat and if the environment is an aircraft cabin, the feature of absolute emplacement of the seat with respect to the aircraft cabin may be written: “the seat is inside the aircraft cabin”. The dimensions of the seat are thus limited by the dimensions of the aircraft cabin. If the recurring component is now a “window seat in a row comprising two seats”, the possibilities of emplacements of said seat within the aircraft cabin are specified and restrained.

The set of technical features of each recurring component has a first variability. The first variability may notably be an interval of allowed values and/or an interval of excluded values. This first variability ensures the functionality of the recurring component considered. Each recurring component has one or more functions. “Functionality” of a recurring component is taken to mean the fact that its function or functions are ensured. In the case of a seat, one function is: “to enable a passenger to sit down”. The functionality of the seat is thus ensured when its dimensions actually enable an average user to sit down on it. The first variability typically determines a range of possible values for the height of the seat bottom with respect to the floor, and for the width and the depth of the seat bottom given the average size and corpulence of a user. The first variability is intrinsic to each recurring component; in other words, the first variability of a given recurring component only takes account of the functionality of said recurring component, independently of potential other recurring components.

In the case where at least one first technical feature and one second technical feature are identified, a hierarchy may advantageously be established between said first and second technical features. The hierarchy determines an order in which the technical features must be treated to establish the first variability. Alternatively or in addition, a behaviour of the first technical feature as a function of the second technical feature and/or a behaviour of the second technical feature as a function of the first technical feature may be determined.

A second phase Ph2 is the elaboration, for each recurring component identified during the first phase Ph1, of a set of rules that determines a second variability for the set of technical features of each recurring component. The second variability may notably be an interval of allowed values and/or an interval of excluded values. The set of rules determining the second variability of the set of technical features of each recurring component advantageously takes account of the spatial environment of the recurring component considered.
It firstly involves prohibiting collisions: generally speaking, a first component must not be placed on a second component. In other words, a partial or total overlap of the first and second components is prohibited.
It secondly involves prohibiting unsuitable positionings: the position of a first component with respect to a second component may for example be constrained by a rule of type: “the first component must be placed in contact with the second component”, or instead “such a distance, measured along such a direction, must separate the first component from the second component”.

The set of rules comprises a first sub-set of rules specific to a given technical field. This first sub-set of rules notably comprises the safety rules of said technical field, for each recurring component. The safety rules relative to a recurring component of “seat” type are not for example the same, according to whether the aeronautics technical field, the railways technical field or the automobile technical field is considered. Generally speaking, the first sub-set of rules specific to a technical field advantageously comprises all the rules that need to be respected in order to obtain a certification in this technical field for each recurring component or combination of recurring components. The second variability of the set of technical features of each recurring component thus ensures the certifiability of each recurring component. Thanks to the method according to one aspect of the invention, the step of certification of a recurring component is advantageously taken into account and integrated as of the genesis of said recurring component.

The set of rules may advantageously comprise, in a complementary manner:
a second sub-set of rules specific to a given trade of the technical field considered, and/or
a third sub-set of specifications, or constraints, specific to a given player of the trade considered.

In the particular example where the technical field is that of aeronautics, the different trades of the technical field are typically: the trade of operator OPS, the trade of aircraft manufacturer OEM, the trade of equipment manufacturer and the trade of specialist CCC. For a given recurring component, for example a seat, each trade thus has an approach that is specific to it. An operator notably manages the general lay-out of components within an aircraft cabin. Thus, in the example of a seat, the operator is notably interested in the position of the seat within the aircraft cabin, as well as in the dimensions of the seat. An aircraft manufacturer ensures the integration of each component, notably for water inflow points, electrical interfaces, ergonomics. An equipment manufacturer, charged with the manufacture of a component, accesses the information items concerning the structure, the composition, the materials used for this component.

Within a same trade, a first player and a second player may differ from each other by specific requirements, for example of an aesthetic nature, which form the third set of specifications.

A third phase Ph3 is the realisation, for each recurring component identified during the first phase, of an object or reference digital model.

The reference digital model of a given recurring component is realised while taking into account, on the one hand, the technical features of this recurring component, inventoried during the first phase Ph1 and, on the other hand, the set of rules elaborated for this recurring component during the second phase Ph2. In other words, the reference digital model of a given component determines a third variability for the set of technical features of this recurring component. The third variability may be seen as the intersection of the first variability and the second variability. The third variability of a recurring component thus ensures:
the functionality of said recurring component, and
the certifiability of said recurring component for a given technical field.

The third variability of each reference digital model of a recurring component is also called “elasticity”. In other words, several separate realisations of a same recurring component are potentially comprised in a single reference digital model, each separate realisation responding to the functionality and certifiability requirements; two separate realisations having typically between them differences as regards their dimensions and their positioning with respect to an environment, within the limit allowed by the elasticity. A reference digital model of a recurring component may thus be seen as a matrix of this recurring component.

A fourth phase Ph4 is the generation, from a reference digital model of a recurring component, of at least one particular digital model of this recurring component. Each particular digital model is a separate realisation of the recurring component. A particular digital model of a recurring component is typically obtained by choosing a value for each technical feature of said recurring component, the choice of each value being restrained by the third variability, or elasticity, of the reference digital model of said recurring component.

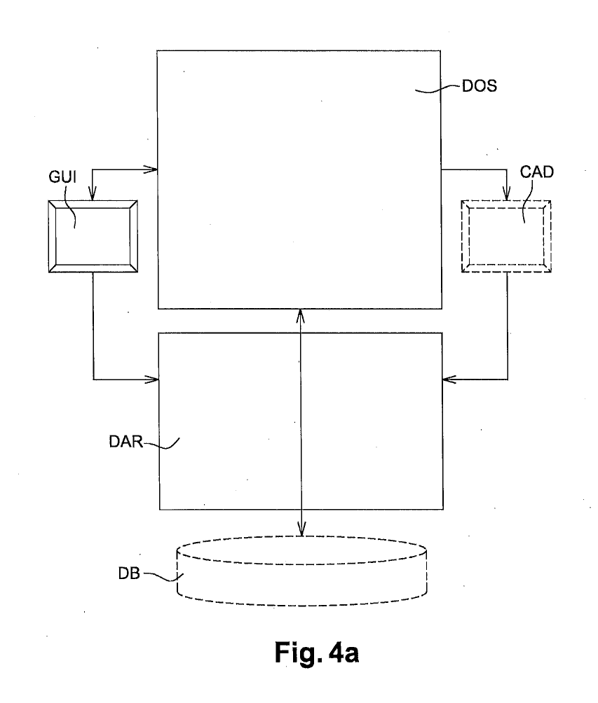

FIG. 3a schematically illustrates a first level Lev1 of operation of the method for three-dimensional modelling according to one aspect of the invention, and the use of a device for three-dimensional modelling according to one aspect of the invention. FIG. 3a shows:
a first module Mod1 of the device for three-dimensional modelling according to one aspect of the invention, and
a second module Mod2 of the device for three-dimensional modelling according to one aspect of the invention.

The first module Mod1 realises:
the construction, for each recurring component, of a reference digital model, and
the storage of each reference digital model of a recurring component within a storage warehouse.

The second module Mod2 realises, as a function of a user of said device for three-dimensional modelling according to one aspect of the invention, that is to say as a function of a technical field or a trade of a technical field or a player of a technical field:
the personalisation of the set of rules that determines the second variability for the set of technical features of each recurring component, and
the personalisation of a user interface.

When the personalisation of the set of rules determining the second variability is realised as a function of a technical field, the first sub-set of the set of rules is adapted. When the personalisation of the set of rules determining the second variability is realised as a function of a trade of a technical field, the first sub-set and the second sub-set of the set of rules are adapted. When the personalisation of the set of rules determining the second variability is realised as a function of a player of a technical field, the first, second and third sub-sets of the set of rules are adapted.

FIG. 3a also shows:
a first step St1 of the method for three-dimensional modelling according to one aspect of the invention, and
a second step St2 of the method for three-dimensional modelling according to one aspect of the invention.

The first step St1 comprises:
a sub-step wherein the user selects a value for each technical feature of a recurring component, the selection of each value being restrained by the third variability, or elasticity, of the reference digital model of said recurring component;
a sub-step of generating, by means of a computer, a particular digital model of this recurring component, the functionality and the certifiability of the particular digital model being ensured.

The second step St2 comprises:
advantageously, a sub-step wherein the user shares the particular digital model with one or more collaborators;
a sub-step of storing the particular digital model of the recurring component within the storage warehouse. Thus, the work of the user, that is to say the selection of the values of the technical features, as well as the work of the computer, that is to say the calculation and compilation time, are capitalised on. The particular digital model of the recurring component may be immediately and indefinitely re-used.

FIG. 3b schematically illustrates a second level Lev2 of operation of the method for three-dimensional modelling according to one aspect of the invention, and the use of a device for three-dimensional modelling according to one aspect of the invention. FIG. 3b shows:
an upstream work up_W of evaluation and understanding of the needs of a user, or “player”, and determining a set of specifications and requirements specific to this user. The set of specifications and requirements specific to a given user, which is determined during the upstream work up_W, is advantageously used as input data for the second personalisation module Mod2 of the set of rules determining the second variability and the personalisation of the user interface;
a downstream benefit dw_B of transformation, for a given recurring component, of a conventional V cycle into a new accelerated cycle, called “I cycle”.

FIG. 3b also shows:
a preliminary step StO of the method for three-dimensional modelling according to one aspect of the invention, and
a third step St3 of the method for three-dimensional modelling according to one aspect of the invention.

The preliminary step StO comprises:
a sub-step wherein the user selects the degree of information relative to each recurring component. During this sub-step, the user can thus select the number and the nature of the technical features of each recurring component. The user can thus allow the use of a technical feature, for example by selecting and activating said technical feature from a list of technical features. Conversely, the user may prohibit the use of a technical feature, for example by deactivating said technical feature from a list of technical features. By allowing or prohibiting certain features, the user determines the degree of automation of the method for digital modelling according to one aspect of the invention. The greater the number of allowed technical features, the greater the degree of automation. The first, second and third variabilities are established later for the technical features that have been allowed during this sub-step;
in the case where at least one first technical feature and one second technical feature are allowed, a sub-step of establishing a hierarchy between said first and second technical features, that is to say a priority rule between said first and second technical features.

The third step St3 comprises:
a sub-step of productive integration of the particular digital model of a recurring component, generated at the end of the first step St1, within a three-dimensional environment. “Productive integration” is taken to mean the fact that the correct integration, without any error or “clash”, of the particular digital model of said recurring component within the three-dimensional environment, is ensured. The risk of error, and the obligation that ensues therefrom to rework the modelling of a same recurring component several times, are eliminated. The particular digital model of a recurring component is, by definition, right first time.

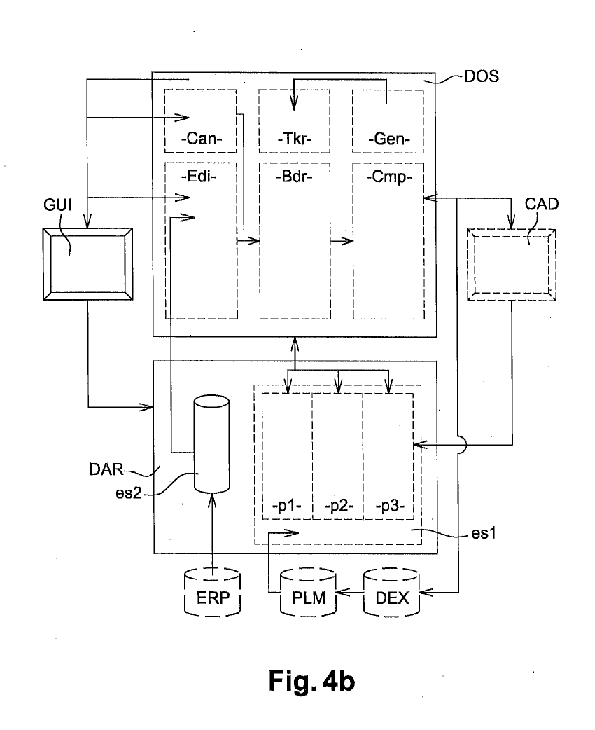

FIG. 4a shows a first schematic representation of a device for three-dimensional digital modelling according to one aspect of the invention.

The device for three-dimensional digital modelling according to one aspect of the invention thus comprises:
a three-dimensional digital object—or model—solver DOS (Digital Object Solver) computer;
a digital storage warehouse DAR (Digital Asset Repository).

The computer DOS orders the generation, for each recurring component, of a reference digital model. From the reference digital model of each recurring component, the computer DOS advantageously orders the generation of at least one particular digital model, and preferentially a plurality of particular digital models. The computer DOS thus comprises the first module Mod1 and the second module Mod2 described previously with reference to FIG. 3a.

The digital storage warehouse DAR comprises:
a first space es1, represented in FIG. 4b, for the storage of:
   the reference digital model of each recurring component,
   as well as each particular digital model of a recurring component, generated by the computer DOS from the reference digital model of said recurring component;
a second space es2, represented in FIG. 4b, for the storage of:
   the set of technical features of each recurring component, having the first variability,
   and the set of rules determining the second variability for said set of technical features of each recurring component.

The device for three-dimensional digital modelling according to one aspect of the invention advantageously further comprises a user interface, and preferentially a GUI (graphical user interface). Alternatively, the user interface may be a command line interface. The graphical user interface GUI enables a user to interact with the computer DOS and/or with the digital storage warehouse DAR, in order to generate and/or to send one or more particular digital models of a recurring component of which the reference digital model is stored in the digital storage warehouse DAR. The graphical user interface GUI typically comprises a screen, a keyboard and a mouse.

FIG. 4a further shows:
an external database DB, comprising a set of data relative to the management of user resources, to the management of the lifecycle of each product, that is to say of each recurring component, and to the exchange of data. An exchange of data may advantageously be an exchange of files of particular digital models between several persons of a same user team, and/or between a user and a client of this user. Generally speaking, the exchange of data is advantageously regulated, that is to say subjected to certain conditions: exchanges respecting said conditions are allowed; exchanges not respecting said conditions are prohibited;
a CAD (Computer-Aided Design) system.

The device for three-dimensional digital modelling according to one aspect of the invention is advantageously compatible with all types of CAD systems. It is typically the user of the device for three-dimensional modelling according to one aspect of the invention who selects the CAD system with which he wishes to work. As an example, the CAD system may thus be: CATIA, SolidWorks, PTC (registered trademarks). The CAD system executes the compilation of the particular digital model or models of each recurring component generated by the computer DOS.

FIG. 4b shows a second schematic representation of the device for three-dimensional digital modelling according to one aspect of the invention.

FIG. 4b thus shows that the computer DOS comprises:
a first part called “editor” and referenced “Edi”;
a second part called “outline” and referenced “Can”;
a third part called “builder” and referenced “Bdr”;
a fourth part called “tracker” and referenced “Tkr”;
a fifth part called “generator” and referenced “Gen”;
a sixth part called “compiler” and referenced “Cmp”.

The editor Edi allows the user to edit the set of technical features of each recurring component, having the first variability, as well as the set of rules determining the second variability for said set of technical features of each recurring component. In other words, the editor Edi allows the user:
to select the degree of information relative to each recurring component, that is to say the number and the nature of the technical features of each recurring component. The user may thus allow or prohibit the use of each technical feature;
and/or to personalise the set of rules determining the second variability, that is to say select the number and the nature of the rules of said set. The user may thus allow or prohibit the use of each rule of said set.

The user advantageously interacts with the editor Edi of the computer DOS through the graphical user interface GUI.

The editor Edi thus contributes to ensuring the adaptability of the device for three-dimensional digital modelling according to one aspect of the invention, as a function of the expectations and requirements specific to each user. In the particular case where the technical field considered is that of the aeronautics industry, four types of users may mainly be distinguished, corresponding to the four main trades of the aeronautics industry:
the user-operator;
the user-aircraft manufacturer;
the user-equipment manufacturer and the user-specialist.

The second part “outline” Can enables the generation, for the reference digital model of each recurring component, of a component mask.

Said component mask comprises typically an input window for each technical feature of said recurring component. The input window of a technical feature enables the user to input, through the graphical user interface GUI, a value for said technical feature. The input may be non-restricted: in this case, the user inputs the value of his choice in the input widow. Alternatively, the input may be restricted: in this case, the user selects a value from a pre-established list of values. The pre-established list of values is typically in the form of a dropdown list under the window of the technical feature considered. There advantageously exists several variants of the component mask of a given reference digital model, as a function of the choices made by the user in the editor Edi.

The component mask of the reference digital model of a given recurring component further advantageously comprises a graphic representation of said recurring component, and notably the technical features of said recurring component. The input window of each technical feature is then advantageously placed near to the graphic representation of said technical feature. The work of the user is thus facilitated, thanks to a good visualisation and to an overall view of the recurring component to be dimensioned.

The second part “outline” Can also advantageously enables the generation, for a particular digital model of a recurring component, of an environment mask. Said environment mask enables the integration of said particular digital model in a spatial environment. The spatial environment typically comprises a plurality of particular digital models of recurring components, which have been integrated beforehand in said spatial environment. “Integration of a particular digital model in a spatial environment” is taken to mean the fact that the particular digital model is laid out in the spatial environment while taking account of:
the geometric and dimensional features of the spatial environment,
and the set of particular digital models that have potentially been integrated beforehand in the spatial environment.

The integration of a particular digital model of a recurring component in a spatial environment thus ensures notably:
an absence of collision between said particular digital model and the set of particular digital models that have potentially been integrated beforehand in said spatial environment;
a compliant positioning of said particular digital model relative to the set of particular digital models that have potentially been integrated beforehand in said spatial environment. “Compliant positioning” is taken to mean a positioning respecting the set of rules that determines the second variability of the set of technical features of said recurring component.

The builder Bdr makes it possible to generate a particular digital model of a recurring component, from:
the component mask of said recurring component supplied by the outline Can, or
the component mask of said recurring component and the environment mask of said recurring component, supplied by the outline Can.

The first case cited enables a user to generate a particular digital model of said recurring component; independently of the spatial environment of said recurring component. The second case cited advantageously enables a user to generate a particular digital model of said recurring component, the particular digital model being integrated in its spatial environment.

The builder Bdr realises a control and a verification of the adequacy between the parameterisation realised by the user, that is to say the set of values input by the user for the set of technical features of the recurring component considered, and:
on the one hand, the first variability of the set of technical features of the recurring component considered, which ensures the functionality of the recurring component considered,
as well as, on the other hand, the set of rules determining the second variability of the set of technical features of the recurring component considered, which ensures the certifiability of the recurring component considered.

If the builder Bdr detects an incompatibility between the parameterisation realised by the user and said first variability ensuring the functionality of the recurring component considered and/or said second variability ensuring the certifiability of the recurring component considered, the builder Bdr asks the user to modify the parameterisation, for example by means of an error message displayed by the graphical user interface GUI. The user is then advantageously reoriented to the component mask of the recurring component considered and/or to the environment mask of the recurring component considered.

Each particular digital model finally generated by the builder Bdr is ensured to be compliant and error-free, from the viewpoint of the initially defined first variability and the second variability.

Each particular digital model generated by the builder Bdr is sent to the digital storage warehouse DAR to be stored therein.

The tracker Tkr advantageously ensures the identification of each particular digital model generated by the builder Bdr. The tracker Tkr associates, with each particular digital model, an identifier of said particular digital model. The identifier of said particular digital model is also called “tag”. The identifier of a particular digital model, or tag, of a recurring component advantageously comprises the complete initial specification of said recurring component, in other words:
the number and the nature of the technical features of said recurring component, chosen by the user by means of the editor Edi;
the values of each of said technical features, input by the user by means of the component mask supplied by the outline Can as well as, advantageously, by means of the environment mask supplied by the outline Can.

In the case of failure of a recurring component having been identified beforehand by a tag, the tag of said recurring component significantly facilitates and accelerates the diagnostic of the failure of said recurring component, then the maintenance or the replacement of said recurring component. In fact, all the features that must be respected by said recurring component in order to ensure its functionality and its certifiability are found in the tag. The tag of a recurring component thus ensures a function of documentation of said recurring component, and contributes to the quality of said recurring component.

The tracker Tkr advantageously fixes, in a given format, the initial specification of said recurring component.

The generator Gen advantageously ensures the encryption of the tag of a recurring component. The inviolability of the tag of said recurring component is thus advantageously ensured.

Finally, the compiler Cmp realises the interface between the computer DOS and the CAD system.

FIG. 4b also shows that the first space es1 of the digital storage warehouse DAR comprises:
a first part p1 for the storage of:
   each reference digital model of “elementary” type, and
   each particular digital model, from the builder Bdr, and of “elementary” type;
a second part p2 for the storage of:
   each reference digital model of “mixed” type, and
   each particular digital model, from the builder Bdr, and of “mixed” type;
a third part p3 for the storage of:
   each reference digital model of “environment” type, and
   each particular digital model, from the builder Bdr, and of “environment” type.

“Particular digital model of environment type” is taken to mean a particular digital model that is integrated in a determined spatial environment. “Reference digital model of environment type” is taken to mean a reference digital model intended to be integrated in a determined spatial environment.

“Particular digital model of elementary type” is taken to mean a particular digital model considered as such, and which is not integrated in a spatial environment. “Reference digital model of elementary type” is taken to mean a reference digital model considered as such, and which is not a priori intended to be integrated in such a type of determined spatial environment.

“Particular digital model of mixed type” is taken to mean a particular digital model being able to behave alternatively like a particular digital model of elementary type or as a particular digital model of environment type. “Reference digital model of mixed type” is taken to mean a reference digital model that can behave alternatively like a reference digital model of elementary type or like a reference digital model of environment type.

As a function of the needs of a user, that is to say typically as a function of the trade of said user, a reference digital model of elementary type and a particular digital model may have different degrees of maturity. In other words, a reference digital model and a particular digital model can be broken down in different ways. Each degree of maturity corresponds in fact to a certain breakdown, which comprises a certain number of elements. Generally speaking, the larger the number of elements comprised in the breakdown, the higher the degree of maturity of the reference digital model or the particular digital model. Thus, there exist several separate breakdowns of a same recurring component as a function of the considered user of the device for three-dimensional digital modelling according to one aspect of the invention.

For a reference digital model or for a particular digital model of a recurring component, the following three degrees of maturity are preferentially distinguished:
a first degree of maturity linked to the absolute emplacement of said recurring component within a given environment. In the particular example of the technical field of the aeronautics industry, this first degree of maturity comprises information useful to a user-operator;
a second degree of maturity linked to the technical features of said recurring component, which ensure the functionality of said recurring component. In the particular example of the technical field of the aeronautics industry, this second degree of maturity comprises information useful to a user-aircraft manufacturer;
a third degree of maturity linked to the precise internal structure of said recurring component. In the particular example of the technical field of the aeronautics industry, this third degree of maturity comprises information useful to a user-equipment manufacturer or to a user-specialist.

1. A method for three-dimensional modelling of a component, the method comprising:
selecting by a user, by means of an interface, a three-dimensional reference model from a plurality of three-dimensional reference models which are stored in a digital storage warehouse, each three-dimensional reference model modelling a component, each component having a list of technical features;
selecting by the user, by means of the interface, at least part of the technical features of the list of technical features of said component, said at least part of the technical features having a first variability which ensures the functionality of said component;
inputting by the user, by means of the interface, a value for each technical feature of said at least part of the technical features;
checking by a computer a compliance of each value input by the user with respect to the first variability ensuring the functionality of the component and with respect to a second variability of said at least part of the technical features, the second variability ensuring a certifiability of the component;
in the case of compliance of each value input by the user with respect to the first and second variabilities, generating, by means of the computer, a particular digital model of the component, the functionality and the certifiability of which are ensured;
automatic and error-free integrating, by means of the computer, of the particular digital model of the component in a spatial environment.

2. The method according to claim 1, comprising storing the particular digital model of the component in the digital storage warehouse.

3. The method according to claim 1, wherein:
said at least part of the technical features comprises a first technical feature and a second technical feature, and
a priority rule is established between said first and second technical features, and/or
a behaviour rule of the first technical feature as a function of the second technical feature and/or a behaviour rule of the second technical feature as a function of the first technical feature are determined.

4. The method according to claim 1, wherein the first variability of said at least part of the technical features of the list of technical features of said component is established as a function of the functional dimensions of said component.

5. The method according to claim 1, wherein the second variability of said at least part of the technical features of the list of technical features of said component is established as a function of a first sub-set of rules specific to a given technical field.

6. The method according to claim 5, wherein the second variability of said at least part of the technical features of the list of technical features of said component is established as a function of:
a second sub-set of rules specific to a given trade of the technical field considered, and/or
a third sub-set of specifications specific to a given player of the trade considered.

7. The method according to claim 1, further comprising identifying, by means of the computer, of the particular digital model of the component by means of a tag, the tag comprising:
the technical features of said at least part of said list of technical features of said component, and
the values of each of said technical features.

8. The method according to claim 7, further comprising encrypting, by means of the computer, of said tag in order to ensure the inviolability of said tag.

9. A non-transitory computer component comprising instructions for implementing the method for three-dimensional modelling of a component according to claim 1.
